(19) United States
(12) Patent Application Publication
(10) Pub. No.: US 2013/0014843 A1
(43) Pub. Date: Jan. 17, 2013

(54) PRESSURE ENHANCING DEVICE

(71) Applicant: Alan Derek Wright, Norwich (GB)

(72) Inventor: Alan Derek Wright, Norwich (GB)

(21) Appl. No.: 13/516,847

(22) PCT Filed: Dec. 17, 2010
(86) PCT No.: PCT/EP10/70007

§ 371 Date: Jun. 18, 2012

(30) Foreign Application Priority Data
Dec. 17, 2009 (GB) 0922034.4
Dec. 17, 2009 (GB) 0922036.9
Jan. 26, 2010 (GB) 1001186.4
Feb. 17, 2010 (GB) 1002710.0
Dec. 6, 2010 (GB) 1020642.3

(51) Int. Cl. F17D 3/00

(52) U.S. Cl. 137/599.01

(57) ABSTRACT

A device is provided for increasing fluid pressure, the device having a first conduit having a fluid inlet and outlet, the first conduit provided with a non-return valve and a second, bypass, conduit having bypass inlet and by pass outlet connected to the first conduit either side of the non-return valve, which bypass is provided with a pumping means. The pump may be sized such that the device can deliver a high pressure of fluid to a low flow-rate demand outlet downstream thereof whilst the device allow a high flow-rate demand downstream of the device to be supplied at low pressure as and when required resulting in a much cheaper, more efficient and more durable pumping arrangement, useable in several applications.

### FIELD OF THE INVENTION

This invention is concerned with a device and method for enhancing the pressure of a fluid and/or enhancing the transport of a fluid. It finds particular application in domestic plumbing (such as supply of water to a home or enhancement of pressure to an individual outlet such as a shower), civil/municipal water engineering, transport of oil and gas and medical applications.

### BACKGROUND OF THE INVENTION

Pumping and transport of fluids is commonplace in many industries and is an essential step in various processes and applications in a range of industries. Particular industries of interest in the pumping or transport of fluid include chemical processing, oil and gas exploration and extraction, municipal water and sewage systems, domestic plumbing, microfluidic applications and medical applications.

A common problem is that in order to pump a fluid from a first point to a second point especially where there is insufficient pressure differential for the fluid to travel by gravity (hydraulic head at one end being greater than that at the other), a pump is typically fitted in-line to the flow of fluid (e.g. a fluid conduit or pipe)—this pump is commonly referred to as a shunt pump if it is close to the source or an on-line booster if it is more remote from the source, both of which are installed on-line (i.e. within the line of the primary flow conduit). However, an on-line booster pump is typically sized to pump all of the fluid required from the first point to the second point at the maximum pressure that will be required and at the maximum flow-rate that will be required.

There are several disadvantages with this arrangement, the details of which depend upon the particular application or purpose of fluid transport or pumping. For example, if seeking to enhance a pressure of fluid at one of a plurality of ‘downstream’ outlets, a pump is typically sized to achieve the maximum flow rate required for any outlet and the maximum pressure required at any outlet, such that the pump is not running most efficiently and considerably more power is used than is necessary. A further disadvantage with many pumps is that if the pump breaks down, the passage of fluid may be prevented even at the un-pressurised pressure.

The typical arrangements for fluid transport in a municipal water supply are as follows. It is common to use pressure pipes which are rated at 8, 10, 16, and 25 bars pressures and to use pumps which pump at these pressures to supply a minimum head of 1 bar at the supply boundary. This is typical because there is significant pressure loss pumping over long distances.

In municipal water supply it is typical that the customer demand will vary during the day and peak demand may be 2.5 times base line demand. The current solution is to provide variable speed pumps or duty assist pumps, but in all cases these pumps are on-line such that at least one pump is within the primary fluid stream. The most energy efficient pumping system needs a constant demand of 1.0 (energy required is approximately 1.0×1.0=1.0) as at 2.5 flow when demand is at its highest, head loss is also 2.5 times higher so the energy required is 2.5×2.5=6.25 (i.e. 6.25 times that required to pump the base load). It is therefore common practice to use multiple pumps or even multiple variable speed pumps at the source. Pump efficiencies are sacrificed as a single speed pump pumping at its duty point is not possible and less efficient pumping arrangements such as multiple speed pumps or duty assist pumps are used.

As an alternative to putting all the pumps at a source an on-line booster may be installed. However, at times when demand is low and a single pump at the source or just gravity flow would have sufficed the on-line pump now switched off within the primary flow conduit creates considerable head loss and maintenance issues.

In a domestic plumbing application, the problem of variations in flow is further complicated by the requirement for a certain minimum pressure to operate at individual outlets (e.g. showers). For example, a bath may require a high volume of water (e.g. 30 litres per minute) but does not require a high pressure, whereas a shower requires a much lower rate of supply of water (e.g. 6 litres per minute) but at a higher pressure (e.g. 5 metres head). If the existing head of pressure in the supply is sufficient for filling a bath at the desired flow rate, all that is needed in addition is 6 litres per minute flow at 5 metres head pressure for a shower. The power requirement for pumping this supply is approximately 15 Watts. If, however, water is supplied at the maximum flow-rate (e.g. 30 litres per minute) and maximum pressure required (5 metres head of pressure), the power requirement approximates to 75 Watts. With a conventional on-line pump solution the energy requirements are further increased since the volute size of, say, a 15 mm pump is larger for the larger flow-rate required and the output of a typical entry level shower pump such as the Watermill Wasp™ 50—a 1.5 bar centrifugal shower pump—is 270 Watts, utilising 18 times the power required for achieving the desired shower pressure.

With any on-line pump, if it is turned off or breaks down there are considerable head losses as water forces through the pump and flows that could be achieved without the pump can no longer be achieved. With a traditional shower pump, such as the Watermill Wasp™ 50, there is a danger of it either taking too much water to a shower so that it starves the system (and perhaps a washing machine feed stops working) or if installed into a primary conduit feeding other taps and appliances, when turned off or broken down it again causes a blockage (and perhaps a washing machine feed stops working). To avoid this outcome, a separate pipe to the shower from a hot water system may be fitted, which extra materials and labour (and the requirement of a separate electricity supply) render this an expensive option.

There is a need for improved pump arrangement that can allow more appropriate sizing of a pump to meet a specific requirements when and only when required (thereby reducing power demand for pumping) without prejudice to the base flows (especially in circumstances when increasing pressures would otherwise be impractical or failure of an on-line pump catastrophic.

### PROBLEM TO BE SOLVED BY THE INVENTION

There is a need for an improved pump arrangement whereby a pump for a particular purpose (e.g. an outlet having a fluid pressure requirement) can be sized appropriately whilst allowing multiple pressure and/or flow requirements to be met.

There is a need for an improved pump arrangement whereby a pump for a particular flow and pressure requirement can be provided without prejudice to greater or lesser base flows and/or pressures. Further, there is a need for a pump arrangement whereby if the pump is not operational (or breaks), this is without prejudice to greater or lesser base flows in the primary conduit.

There is further a need for an arrangement whereby water drawn from a hot water outlet is hot negating the need for cold water run-off.

It is an object of the invention to provide an improved pump arrangement which allows more efficient sizing of a pump for its purpose (resulting in reduced cost and energy consumption).

It is a further object to provide a device which can pump a fluid at a first low flow rate at a first high pressure whilst allowing for the flow of fluid at a second high flow rate at a second low pressure.

It is a further object to provide such a device or pump arrangement for use in domestic/commercial/industrial water systems, medical applications, microfluidic applications such as inkjet printing and/or civil/municipal water distribution.

### SUMMARY OF THE INVENTION

In accordance with a first aspect of the invention, there is provided device for increasing fluid pressure the device having a fluid inlet, a fluid outlet, a first conduit connecting the fluid inlet and fluid outlet, the first conduit provided with a non-return valve; a second conduit connected to the first conduit by a branch inlet and a branch outlet, the branch inlet and branch outlet configured relative the first conduit to connect the second conduit to the first conduit either side of the non-return valve, wherein the second conduit is provided with a fluid pump.

In a second aspect of the invention, there is provided a method for increasing the pressure of a fluid, the method comprising providing in a fluid conduit the above device whereby fluid downstream of the device may have a raised pressure.

In a third aspect of the invention, there is provided a method for selectively increasing the pressure of a fluid through a conduit at low flow rates, the method comprising providing a device as defined above in which the pump is sized to provide a desired increase in pressure to a pre-determined maximum flow rate, above which the fluid is provided downstream of the device at substantially the same pressure as upstream of the device.

In a fourth aspect of the invention, there is provided an implantable pumping device for medical use, the pumping device being as defined above.

In a fifth aspect of the invention, there is provided a domestic/commercial/industrial plumbing arrangement comprising a device as defined above.

In a sixth aspect of the invention, there is provided municipal water supply having a device as defined above.

In a seventh aspect of the invention, there is provided a microfluidic device having a pumping device as defined above.

In an eighth aspect of the invention, there is provided an oil or gas pipeline having a device as defined above.

In a ninth aspect of the invention, there is provided a fluid/heat saving arrangement, comprising a heated fluid source, an outlet for drawing said fluid, a fluid supply line for supplying fluid to the outlet from the fluid source, a return line for returning fluid to the fluid source, a return outlet for feeding fluid from the return line to the fluid source (or a temporary reservoir associated with the fluid source) and a return inlet feeding fluid from the fluid supply line to the return line at a point proximal to the fluid outlet, the arrangement being characterized in that there is provided in the fluid supply line (or the return line) a device, as defined above, for circulating said fluid from the heated fluid source, through the fluid supply line, through the return line and back to the fluid source.

In a tenth aspect of the invention, there is provided a method for providing a fluid outlet with hot fluid from a heated fluid source without having to run off residual cool fluid, the method comprising providing a return line from a supply line feeding the outlet from the source at a position proximal the fluid outlet and providing in the fluid supply line a device as defined herein for pumping fluid from the heated fluid source, through the supply line and back to the fluid source via the return line, whereby heated water is available to be drawn from the fluid outlet from the position proximal the fluid outlet on demand.

### ADVANTAGES OF THE INVENTION

The device and pump arrangement of the present invention provide a means for increasing pressure of fluid through a conduit and are particularly effective at enabling a relatively low fluid flow to be pumped at a relatively high pressure, while enabling a relatively high flow rate to be drawn through the same conduit at relatively low pressures, whereby a pump may be selected for most efficient operation by being appropriately sized for the high pressure requirement. The device and pump arrangement has the further advantage that outlet flow is independent of the operation of the pump, hence if the pump fails, fluid may still be drawn through the conduit at a rate and flow substantially as was achieved prior to the installation of the device. Still further, by utilizing the device and method of the invention, a very low capital cost pump, which is very quiet and economical to run can be utilized in certain applications compared with the conventional noisy and costly alternative.

In the particular application of the invention of saving fluid at a heated fluid outlet, there is a particular advantage that fluid (cool or partially warmed) is not wasted while running off in the provision of hot fluid to a user and power is not wasted in pumping fluid to a location only to be run-off while the user waits for the fluid to get hot.

### BRIEF DESCRIPTION OF THE DRAWINGS

FIG. 1 illustrates a device of one aspect of the invention;

FIG. 2 illustrates a solar water heating system according to another aspect utilizing a device of FIG. 1 for fluid transit;

FIG. 3 illustrates a water/fluid saving arrangement in a domestic plumbing system, according to a further aspect, which utilizes a device according to FIG. 1;

FIG. 4 illustrates a novel tubing according to a related aspect useable in an arrangement according to FIG. 3; and

FIG. 5 illustrates an alternative embodiment of the device of FIG. 1.

### DETAILED DESCRIPTION OF THE INVENTION

The invention in its main aspect is a device for enhancing the pressure of a fluid flowing through a conduit, and preferably for enhancing the pressure of fluid having an existing applied pressure or head of pressure (e.g. the device may be considered as comprising an auxiliary pump).

Preferably the device may be utilized to provide enhanced pressure of fluid up to a pre-determined flow rate, by selecting a pumping means to operate at that pre-determined flow rate.

As stated above, the device in the main aspect has a first, main, conduit for supply of fluid (typically having a head of pressure applied to it e.g. by another (e.g. external) source) to a downstream conduit which downstream conduit may have one or a plurality of outlets (or branch conduits). The device is characterized by having a non-return valve (or one-way valve) in the first conduit which will allow flow of fluid through the valve in the direction of intended flow (i.e. from intended source to intended destination), the first flow direction (the second flow direction being typically a direction opposing the first flow direction), but which will not allow flow of fluid in the opposing direction (i.e. the second flow direction); and by having a second conduit as a bypass to the first conduit and connected thereto by a bypass inlet and a bypass outlet respectively on either side of the non-return valve, the second conduit provided with a pumping means for pumping fluid in the first direction (as defined above). A non-return valve may, depending upon the industry or technology in which it is used, be referred to as a one-way valve, a check valve or a flap valve.

Activation of the pumping means (to a pressure greater than the head of pressure of fluid being provided to the inlet of the device) causes a pressure differential (or discontinuity) either side of the non-return valve, which causes the non-return valve to close and the fluid to be pumped through the second conduit and to the downstream conduit at up to the maximum flow-rate and pressure of the pumping means (specific to that particular pumping means). The creation of a pressure differential or discontinuity (upstream and downstream) about the non-return valve allows an increased pressure of fluid (relative to the pressure of fluid supplied to the device) to be pumped to the downstream portion of the conduit. When operating at a flow rate greater than the capacity of the pumping means (i.e. when the demand is greater than the capacity of the pumping means), or when the pumping means is not activated, the pressure differential is removed and the non-return valve opens to allow the flow of fluid in the first direction substantially unimpeded. However, it is recognized in industry that the provision of a non-return valve in a conduit (e.g. a water pipe) will create head loss and thus it is counter-intuitive to incorporate a pressure-reducing element in a device intended to provide increased down-stream pressure. The by-pass conduit, however, is capable of providing a means for increasing fluid flow and compensates for any pressure reducing effect of the non-return valve on the first conduit. Thus, when fluid flow-rate demand at an outlet served by the device exceeds the capacity of the pumping means, the non-return valve opens (since the differential pressure about the non-return valve is now such that it is allowed to open) and the fluid is delivered to the demand outlet at the flow rate and head of pressure of fluid corresponding to that provided to the inlet of the device.

The pumping means may be sized to pump a desired maximum pressure (larger than the pressure of fluid provided to the device) at any flow-rate desired, more or less than the flow rate provided to the device. Preferably, however, for many applications, the pumping means is sized to pump a desired maximum pressure required by any outlet fed by the downstream conduit, but sized to pump a flow-rate (capacity) less than the maximum flow-fate achievable through the first conduit and/or a flow-rate less than the maximum flow-rate demanded by any (not each) outlet served by the downstream conduit.

Preferably, the pumping means is an electrically powered pump. Optionally, especially for lower-powered operations, the pump may be operated by battery, so that it can operate remote from a fixed power source. The efficient operation of the pump (e.g. at relatively low flow rates) ensures that power demand is significantly lower than conventional pumping arrangements, whereby a battery power source may be used.

The size of the pump utilized depends upon the typical flow rates of fluid, the maximum demand in terms of fluid pressure at a pre-determined flow-rate and the maximum flow-rate at which that maximum pressure is required.

The second conduit should preferably have a length of no greater than four times that of the portion of the first conduit that it by-passes, more preferably no greater than three times that of the portion of the first conduit that it by-passes, still more preferably no greater than twice that of the portion of the first conduit that it by-passes and most preferably no greater than 1.5 times that of the portion of the first conduit that it by-passes and still more preferably, the second (by-pass) conduit is up to 1.25 times the length of the portion of the first conduit that it by-passes and optionally up to 1.1 times. In one embodiment, the second conduit may be the same length or shorter than the portion of the first conduit that it by-passes, for example if the first conduit forms a curved conduit, the curve or corner of which is short-cut by the second conduit.

Preferably, the second conduit is no more than 25 diameters (of the second conduit) in length, more preferably no more than 20 diameters and still more preferably no more than 15 diameters.

The conduits may be of any suitable profile (e.g. rectangular, square, oval or circular), but are preferably circular as is typical in pipe work. The device may be made of a material that may be rigid or pliable depending upon the application of the device. The material may be of any suitable material dependent upon the application. For example, the device may comprise metal pipes (e.g. copper, chrome, silver) or plastic (rigid or flexible) pipes.

In one embodiment, the device comprises a housing having an inlet (corresponding to the first inlet) and outlet (corresponding to the first outlet) in which the conduits are laid out as a pipe arrangement or, alternatively, in which the conduits are formed (e.g. moulded) in a solid body (i.e. conduits are formed rather than pipes). The housing comprises the pumping means and optionally a connection for an external power source or a cavity for connecting and/or housing a battery.

The bore (or radial dimension) of the second conduit can be of any diameter. Typically a pump volute inlet is significantly smaller than the incoming and outgoing pipework such that tapering down to and up from a pump is normally industry practice. Preferably, the diameter of the second conduit (bypass) should be less than that of the first conduit (primary conduit) thereby removing the need to taper down at the pump. In a preferred embodiment, therefore, the bore of the second conduit should preferably be no greater than that of the portion of the first conduit that it by-passes (or of the conduit up-stream of the by-pass inlet), and more typically is of smaller bore, which precise size may in part be determined by the required relative flow-rate of fluid to be increased in pressure. For example, the bore of the second conduit may have a diameter of at least 0.25× the first conduit and optionally up to 1× that of the first conduit, preferably up to 0.9× and more preferably 0.8× the first conduit. More preferably, the second conduit has a diameter of from 0.5× to 0.75× that of the first conduit. For example, in domestic plumbing a first conduit may have a diameter of 28 mm or 22 mm, and a second conduit may have a diameter of 15 mm or 10 mm.

Optionally, the second (bypass) conduit comprises a non-return valve, but preferably the second (bypass) conduit is absent a non-return valve.

Optionally, the device is provided with one or more sensors to which the actuation of the pump is sensitive. For example, the device may be provided with pressure sensors whereby the pump actuates when the pressure falls below a certain level (which may occur when demand, e.g. upstream or downstream, is high). Alternatively, the sensor may be a temperature sensor, whereby a pump in an arrangement for supplying heated fluid to an outlet (as herein described) is actuated in response to the temperature falling below a pre-determined level. As a further example, when the device is required on a fire main when it is adapted to allow flows greater than those normally supplied by the base load, but negative pressures in the incoming main must be avoided absolutely as negative pressures in the incoming main would lead to contamination and health and safety issues (and legal issues dependent upon water bylaws).

A particular advantage of the device of the invention it its simplicity, both in the nature of components and the number of components necessary for effective operation. In a preferred embodiment, therefore, the device of the invention (and as used in each of the associated aspects) consists essentially of (or consists of) a first conduit connecting a fluid inlet and a fluid outlet, the first conduit provided with a non-return valve, a second (bypass) conduit connected to the first conduit by a branch inlet and a branch outlet, the branch inlet and branch outlet configured relative the first conduit to connect the second conduit to the first conduit either side of the non-return valve, and provided in the second conduit a fluid pump for pumping fluid in a first direction (being the same direction as the direction of flow allowed by the non-return valve). Optionally, according to this preferred embodiment, the device further comprises (or consists of) other components as specified herein and/or is sized (and its components sized) for purposes defined herein.

As indicated above, the invention further provides a method for increasing the pressure of a fluid, the method comprising providing in a fluid conduit the device of the invention whereby fluid downstream of the device may have a raised pressure. In a particularly preferred embodiment of this method, the method provides for selectively increasing the pressure of a fluid through a conduit at low flow rates, the method comprising providing a device of the invention (as defined herein) in which the pump is sized to provide a desired increase in pressure to a pre-determined maximum flow rate, above which the fluid is provided downstream of the device at substantially the same pressure as upstream of the device. The implementation of the method of the invention very much depends upon the application and the requirements for pressure and flow-rate of the demand. It is preferred that the method and device of the invention are implemented as auxiliary arrangements in which a fluid is supplied to the device at a head of more than zero, whereby the pressure of fluid supplied may be enhanced at certain flow rates according to the requirements of the user/uses downstream.

A particular advantage of the device and method of the present invention is its flexibility, adaptability and access for maintenance. In particular, two or more devices of the present invention may be utilized in series, for example where fluid is to be transferred over a long distance or up a certain height to a desired destination at a destination flow rate and pressure, whereby a first relatively small pump can be provided at a first location to pump fluid at a specified flow-rate and pressure to a second location downstream of the first location where a second relatively small pump can be provided to pump fluid to the destination at the desired flow-rate and pressure. Accordingly, fluid may be pumped to the destination in a fluid relay manner, first over a first section from the first pump location to the second location and the then over a second section from the second location to the destination. Two smaller pumps may be used instead of one larger pump. This has particular benefits that noise and head associated with larger pumps may be effectively dissipated and hence the cumulative cost of multiple pumps is expected to be lower than a larger pump. Further, should there be a demand at the second location for a large flow-rate of fluid at relatively low pressure and a demand at the destination for a low flow-rate of fluid at a relatively high pressure, a relatively larger capacity pumping means can be provided in the second conduit of the first device at the first location to relay fluid to the second location at high flow rate but relatively low pressure, whereas a relatively smaller capacity pumping means can be provided in the second conduit of the second device to pump fluid at relatively low flow-rate but relatively high pressure to the destination. Hence the overall cumulative power requirements (and generated heat and noise) may be significantly lower in such an arrangement of the present invention.

The device may also be adaptable in parallel, for example it if is desired to increase the capacity (flow-rate) of the pumping means in a device. For example, the device may comprise (or be adaptable to comprise), in one embodiment, one or more further conduits which also bypass the first conduit connecting either side of the non-return valve, each further conduit provided with a pumping means, whereby the cumulative effect of the pumping means in the second and subsequent conduits is to provide fluid at the head of pressure according to the rating of the pumping means at the cumulative flow rate. Optionally, a device with multiple second and subsequent (bypass) conduits may provide a range of pumping pressures and flow-rates according to the capacity and rating of pumps in each bypass conduit and their individual and cumulative effect, for which a demand-detector may be responsible for actuating respective pumping means to deliver a desired pressure/flow rate or which may require a control means for the operation thereof. Alternatively, the device may be adaptable to allow a second and optionally subsequent pumping means to be added in parallel with the first pumping means to the second conduit whereby the capacity of the pumping means (cumulatively) is increased additively. In another embodiment, therefore, the device comprises two or more pumps in parallel provided to the second conduit.

Further, by providing pumping means in a bypass conduit, maintenance and/or replacement of the pumping means can be achieved without cutting off the water supply necessarily. This is particularly the case when an auxiliary device is provided immediately adjacent the device whereby pumping requirement can be met at all times on demand. A still further advantage of the device of the present invention is the capability to utilize a single pump or a plurality of smaller rated pumps either in parallel or in series, which pump or pumps are smaller (lower capacity and in many cases lower capacity and pressure rating) than the conventional alternative, which is advantages when pumping heated water as simpler, smaller pumps may be capable of continuously pumping hot water.

Various embodiments of the invention will now be discussed. In the following discussion in connection with various embodiments preferred features may be described which have particular utility with that embodiment. It should be noted that where the context allows, such preferred features may be considered as more generally applicable or applicable to other embodiments. The following embodiments will be described alongside more substantial arrangements in the particular applications and methods of achieving the desired pressure-increase effect.

The device finds particular utility in several embodiments, which will be discussed, including plumbing (domestic/industrial/commercial), civil/municipal water works, microfluidic devices (e.g. inkjet printers), solar heating systems, and medical devices (e.g. arterial pumps).

According to a first embodiment of the device, there is a device as defined above for use in plumbing (including domestic, commercial or industrial plumbing systems), preferably domestic plumbing systems. Accordingly, the device for this purpose may comprise a first conduit that has a bore diameter of, for example, 10 to 50 mm, more preferably 15 to 30 mm, for example 15 mm, 22 mm or 28 mm (and still more preferably 20 to 25 mm, but most preferably about 22 mm). The second conduit preferably has a bore diameter of 5 to 50 mm, more preferably 10 to 30 mm and most preferably 10 to 20 mm, for example 10 mm or 15 mm. In one particularly preferred embodiment, the device is for connecting to a conduit which serves a domestic shower (and optionally other outlets). Preferably, the pump is sized to deliver a flow-rate and pressure required only for the shower, for example a flow rate in the range 5 to 15 litres/minute, more preferably 6 or 7.5 to 12 litres/minute (e.g. 6 to 10 litres/minute) and most preferably about 6 litres/minute, which is recognized as that required for a ‘good’ shower and preferably to provide a pressure in the range of 2.5 to 20 metres head, more preferably 3 to 10 metres head and still more preferably about 5 metres head. For a domestic shower or domestic plumbing arrangement, it is preferred to use a 6 litres/minute pump (providing 5 metres head), such as the WDB-38A, which is a nominal 12V pump available from Weilibao™.

In utilizing the device according to this embodiment, a domestic plumbing arrangement is provided according to another aspect of the invention as mentioned above in which a device is provided in line in a domestic water supply pipe, e.g. a supply of water from a cold water mains, from a cold water tank or from a hot water tank, to a conduit serving a shower (and optionally other outlets such as a bath faucet). Optionally, the device in this arrangement is operable manually (e.g. by a specific switch or by a switch actuated when the shower is turned on) or in response to a sensor (e.g. measuring flow rate or pressure or temperature through the device inlet whereby if the flow rate or pressure or temperature is below a pre-determined level, the pump is actuated and when the flow rate or pressure or temperature exceeds a pre-determined level the pump deactivates). According to this embodiment, when flow rate to say a bath (as a further outlet) is required then the high flow and low pressure requirements of the bath take precedence and the non-return valve opens to allow flow of water at the head pressure of the supply in the first direction to the bath faucet. There is no longer a pressure differential (or discontinuity) about the non-return valve, so it may not be possible to have a shower and run a bath at the same time. A significant advantage of the invention in the context of feeding a shower outlet, however, is that a 15 W motor for a pump is a very low cost item, very quiet and very economical to run compared with the size of conventional in-line shower pumps.

In another embodiment in which the device is for use in a domestic, industrial or commercial plumbing application, the device may be utilized in the solar fluid heating system described in International Patent Application No. PCT/EP2010/006781, the contents of which are incorporated herein by reference. According to a further aspect, there is provided a solar fluid heating system as defined in PCT/EP2010/006781, which comprises a device as defined herein for pumping fluid about one or more fluid circuits thereof. In particular, a solar fluid heating system comprising a heat capture element (such as a solar panel) and an intermediate fluid tank and a fluid flow circuit therebetween comprising conduits between the heat capture element and intermediate fluid storage tank as well as between the element and an outlet (e.g. to a hot water storage tank) may benefit from one or a plurality of the devices of the present invention provided to one or more of said conduits. It is particularly beneficial in a solar fluid heating system that narrow bore pipes between components of the system are used (in order to minimize heat loss in transit). Further, should the intermediate storage tank and the solar heat capture element be placed at different locations, it is necessary to transfer the fluid along conduits between said elements. The use of one or more devices of the present invention (e.g. in relay and optionally in parallel) allows the effective transfer of fluids very efficiently.

In a further embodiment in which the device finds application in domestic, commercial and/or industrial plumbing arrangements, the device is for use in a fluid and heat saving arrangement as defined above, preferably where the fluid is water and the arrangement finds application between a domestic, commercial and/or industrial heated water source and a heated water outlet (e.g. domestic hot water tap). Preferably, the arrangement is for use in a domestic hot water system.

In utilizing the device according to this embodiment, there is provided a water saving arrangement comprising a heated water source (preferably a hot water tank or optionally a combination boiler), a water supply line serving a faucet from the heated water source, the water supply line provided with a device as herein defined for pumping at low rate, and a return line branching from the supply line at a position proximal the faucet (or other outlet) (e.g. within 30 cm, preferably within 10 cm thereof) to feed (e.g. cooled) water back from the water supply line to the heated water source (e.g. hot water cylinder).

According to this embodiment (utilized in the fluid-saving arrangement), the device is preferably provided in the water supply line serving one or more outlet (or faucet), each outlet provided proximal thereto with a return line, whereby the single device can, optionally, serve the instant hot water requirements for a number of outlets. In use, the device can induce a flow to circulate about the circuit (heated water source-supply line-return line-heated water source) and, when an outlet demand occurs (i.e. the tap is turned on), ready-heated water is drawn from the supply line, without to need to run-off residual cold water. The demand from a faucet typically exceeds the capacity of the pumping means of the device of the invention, causing the non-return valve to open and allow use of the tap as normal.

Optionally, the device for the fluid-saving arrangement may be actuated manually (e.g. by a switch by the faucet) or may be actuated according to a timer (e.g. when demand is most frequent—thereby preventing the device operating all day when use is not likely) or the device is actuated in response to a temperature sensor, e.g. at the inlet to the device or at the junction of supply line and return line.

Preferably the return line should have a restricted flow feature relative the supply line. A restricted flow return line has several benefits including that when the outlet is actuated (and fluid is drawn) the majority or substantially all of the fluid is provided by the supply line (carrying heated water) and not the return line (which may carry cooler water and may be capable of supplying cooler water from a source, such as a cool portion of a hot water storage tank). The restricted flow feature may be provided by providing in the return line one or more of a flow-restriction valve, a partially closed valve, a non-return valve (preventing flow of fluid along the return line in the direction of the outlet, e.g. faucet), a thermostatic valve, or by providing at least a proportion (and preferably the entirety) of the return line with a bore of smaller dimension than the supply line.

In one embodiment, a thermostatic valve or thermostatic valve arrangement may be provided in the return line, which arrangement is configured such that flow through the thermostatic valve (driven by the device of the invention) in a circulatory direction (i.e. from heated source to supply line to return line to heated source) is prevented until the temperature of water feeding into said valve arrangement falls below a pre-determined value, at which point the valve opens to allow water to circulate (and hot water to be provided to the outlet) and when it rises above a pre-determined value, the valve closes. Flow of fluid in the return line in a counter-circulatory direction may be subject to a non-return valve or a second suitably configured thermostatic valve.

Preferably, the restricted flow is provided by at least a portion of the return line having a reduced bore compared with the supply line.

Preferably the return line has a bore that is significantly smaller than the supply line (e.g. where a supply line may be in the range 15 to 30 mm, most typically 22 or 28 mm, a return line may be in the range 2.5 to 15 mm, e.g. 5 to 10 mm), for example in the range 0.25 to 0.75× the bore of the supply line. Thus, the quantity of water ‘standing’ in the return line (and losing heat) is reduced compared with a larger bore return line.

By utilizing a device according to the present invention, the pump for circulating the fluid to ensure instant hot water does not need to be sized to pump the demand of the outlet (or plurality of outlets), but simply to circulate the fluid when the outlet is not open. Thus a significantly smaller pump may be utilized (e.g. in a typical domestic environment, a pump of up to 100 W, preferably up to 50 W, more preferably up to 25 W, still more preferably up to 15 W and most preferably in the range 5 to 10 W may be used (e.g. a 7 W pump). Preferably, the pump has a capacity less than sufficient to meet full flow demand from the demand outlet.

Preferably, the heated water source according to this embodiment is a domestic hot water cylinder. Optionally, in an alternative embodiment, the heated water source may be a domestic combination boiler. In an embodiment where the heated water source is a combination boiler (i.e. instantly heats hot water on demand), there is often a lag between water being heated and delivered to the tap. Preferably, in this embodiment, the device may be actuated to circulate water from the boiler through the supply line, through the return line and back to the boiler inlet on actuation by the user (e.g. by a switch at the faucet or responsive to actuating a faucet, which is associated with a thermostatic valve preventing water being drawn until a pre-determined temperature is achieved). In order to feed water into a boiler (instant boiler, e.g. combination boiler) inlet, it is typically required to be of significantly higher pressure. This may be achieved by providing a device of the invention in the return line proximal the boiler inlet and further characterized in having a one-way valve in the second (bypass) conduit and a significantly larger pump (to circulate fluid at the required pressure). Alternatively, fluid may be fed from the return line into a small feed tank for the boiler inlet, which may be siphoned via a siphon conduit fitted with a non-return valve into the combination boiler inlet.

In a further option of this embodiment, the pumping means of the device may be in operation according to the various means discussed above, or may be constantly in operation (e.g. if it serves a plurality of outlets) and circulation about any particular loop associated with an individual tap may be controlled by manual actuation, e.g. in association with the outlet (e.g. faucet). In one embodiment envisaged by the present inventor, the circulation of water through the loop (heated water source-supply line-return line-heated water source) may be actuated by a plunger or valve configured in the return line, for example at or proximal to (e.g. within 5 cm, preferably within 2 cm of) the junction between the supply line and the return line, which junctions is preferably proximal to (i.e. within 10 cm, preferably within 5 cm and more preferably within 2 cm of) the outlet. Optionally, the plunger or valve is actuated manually using a lever or switch provided on the faucet arrangement. Accordingly, there is provided, in a related aspect, a faucet or tap for drawing at least from a hot water supply line configured with a return line for water and/or heat saving circulation, the faucet or tap configured with a plunger or lever for actuating or deactuating the flow of fluid through the return line by activating or deactivating a plug or valve within the return line. Optionally, the faucet or tap arrangement is provided with a water temperature indicator to indicate the temperature of water at or proximal the junction of the supply line and return line, whereby the tap may then be operated. In an alternative embodiment, the faucet or tap is configured such that activation/deactivation of the return line plug or valve occurs automatically when the faucet or tap is actuated and flow of water through the tap or faucet is delayed until a pre-selected water temperature is reached.

In a further related aspect, there is provided a pipe or tube for use in industrial, commercial or domestic plumbing (preferably domestic) which comprises a first supply conduit of a first bore size and a second return conduit contiguous with the first conduit which second return conduit is of a second bore size, which second bore size is less than the first bore size (preferably up to 0.75× the first bore size, more preferably in the range 0.1 to 0.5× the first bore size and still more preferably in the range 0.15 to 0.25× the first bore size). Preferably, the first supply conduit bore diameter is in the range 15 to 30 mm, most typically 22 or 28 mm, and still more preferably a return conduit may be in the range 2.5 to 15 mm, e.g. 5 to 10 mm. Preferably, the piping or tubing is formed such that a single skin for both first supply conduit and return conduit is provided. Optionally, the first supply conduit and return conduit may be linked by providing at a tubing end or between two lengths of tubing a junction piece linking the first supply conduit and the return conduit, optionally with a third outlet (e.g. to a demand outlet). The tubing may formed of any suitable material, e.g. typical for domestic plumbing such as copper, copper lined or coated copper tubing, or crosslinked polyethylene, PVC or CPVC.

According to a second embodiment of the device, there is a device as defined above for use in municipal water supply systems. In one arrangement utilizing the device according to this embodiment, a municipal water supply system comprises a supply pipe (e.g. of PVC) supplying a water tower. Installation of the device at the base of the water tower is such that the pressure in the PVC supply pipe (mains pipe) is reduced.

In a further municipal application, the water utility could supply water to an upper flat via mains feed when zone pressures are high (e.g. at night), with the invention only operating very occasionally when demand in the supply zone is high (and hence pressure in the supply zone is low) and only when that particular flat needs water. Municipal application find particular benefit in the relay function of the device as described above. In particular, by having more pumping devices such as those of the present invention operating in relay in municipal water supplies, supply pressures close to pumping stations may be reduced, reducing the likelihood and impact of leaks as well as increasing the lifetime of pipes. The devices of the present invention enable maintenance without interrupting water supply.

In printing the viscous nature of inks causes head loss and there is a need to supply inks at specific pressures and flows which is facilitated by the device of the present invention.

In medicine, there is provided a method for the treatment of inhibited circulation, restricted blood flow, ischemia or symptoms thereof comprising providing to a blood vessel (typically an artery) feeding tissue, body part or an organ of which at least a portion is under-supplied, suffers poor circulation or is ischemic a bypass conduit having a bypass inlet and bypass outlet connecting the bypass conduit to a primary conduit, which by-pass conduit is fitted with a pumping means, and wherein the primary conduit is provided with a non-return valve between the bypass inlet and bypass outlet. The treatment of restricted blood flow, poor circulation or ischemia may therefore be achieved by providing an essential boost to increase blood supply close to where it is needed without increasing blood pressure as a whole. Ischemia or an ischemic condition in a peripheral portion is often caused by an arterial blockage or partial arterial blockage or by the additional pressure (or malfunction) of a heart pump, which may result in impaired circulation of blood flow to a peripheral portion of the body (e.g. a limb or digit).

This increase in blood supply could be achieved with a traditional on line pump however if the on line pump failed then the increased restriction in blood supply over and above that which existed prior to the insertion of the pump may result in worsening of the circulation and ischemic condition with resultant significant additional cell death. The innovation by virtue of a bypass conduit according to the present embodiment compensates for the head loss caused by the one way valve inserted in the primary conduit and failure of the pump causes no such risk as flows are always greater than before the device is fitted even if the pump is not operating.

In one embodiment, a blood vessel component (such as a harvested vein section from the patient) may be grafted to an artery to provide the bypass conduit, to which may be fitted the pumping means. According to this embodiment, the primary conduit is provided by the blood vessel or artery supplying the ischemic tissue, which is provided with a non-return valve means. In another embodiment, a complete device as defined above (wherein the first conduit of the device according to the present invention is the primary conduit of this embodiment and the second conduit of the device is the bypass conduit) may be inserted into a blood vessel, e.g. an artery, feeding ischemic tissue. According to this embodiment, no grafting is necessary, other than fitting the device in-line into an artery. The device according to this embodiment is a micro-version of the device defined above and is preferably formed as a single encased component and more preferably comprises medical grade plastics and stainless steel materials. By utilizing the device or intervention described, the average pressure immediately downstream is increased by, say, up to 25%, more preferably up to 15% and still more preferably up to 10% and preferably at least 2% and more preferably at least 5%, based on typical systolic and diastolic resting pressures (e.g. 120 mm Hg over 80 mm Hg). In one embodiment, the pumping means (and the device) may be configured to operate in a pulse-mode whereby the pump is actuated when heart-induced flow and pressure occurs. Optionally, the pump is actuated in response to a pre-determined increase in pressure at the device inlet (e.g. as measured by a pressure sensing device) or by other body sensors (e.g. a heart sensor) said data optionally treated with an appropriate algorithm to ensure congruity. In another embodiment, the pumping means may be configured to operate on a continuous basis (whilst the blood supply pressure varies between pulses driven by the heartbeat), whereby blood may continue to be pumped to the ischemic tissue or organ out of synch with the heart beat. Preferably, according to this embodiment, on the on-beat blood may continue to be supplied via the primary conduit (or first conduit) as the one way valve opens (i.e. the flow-rate exceeds the capacity of the pumping means on the on-beat), whilst on the off-beat, blood continues to flow (toward the ischemic tissue or organ) by virtue of being pumped through the bypass (or second) conduit. Without being bound by theory, it is believed that the continuous pumping of blood through the bypass of the device may be achieved off-beat due to inherent residual pressure of blood in the blood vessel due to flexibility or elasticity of the blood vessel.

A device of the invention utilized according to this embodiment may be sized appropriately. For example, if used on a larger artery, the inlet and conduit may have a diameter of, for example, 5 to 20 mm or 5 to 15 mm, whilst if used on a smaller artery, the device may be sized to have an inlet and conduit diameter of, for example, 0.5 mm to 5 mm, preferably 1 mm to 5 mm. The diameter of the bypass conduit may be similar to the first (or primary) conduit or smaller (e.g. of similar relative proportions as that described above).

The invention will now be described in more detail, without limitation, with reference to the accompanying Figures.

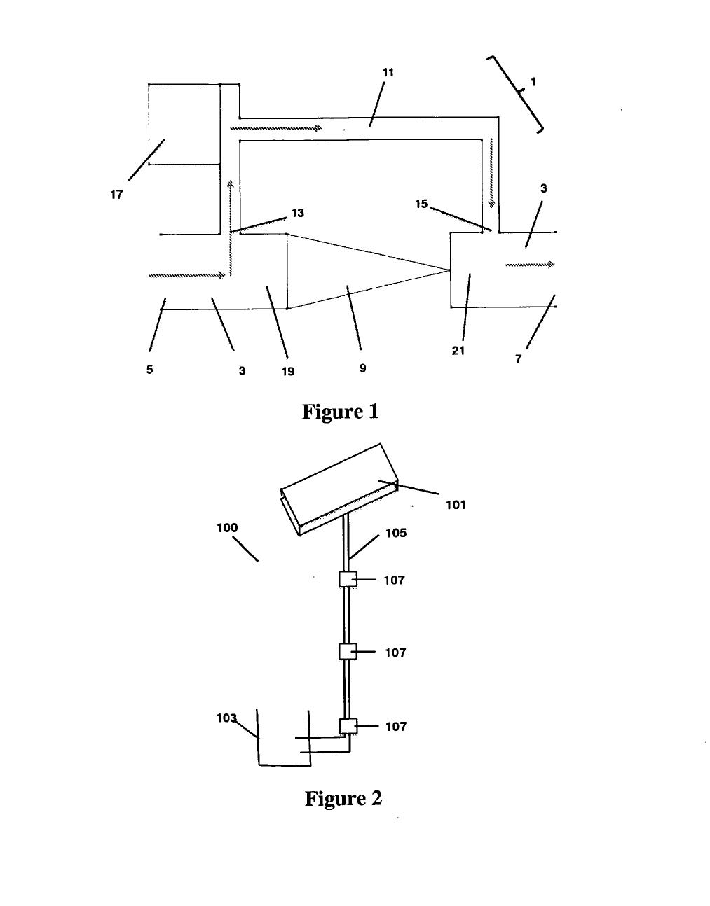

In FIG. 1, a pressure-enhancing device 1 has a first (primary) conduit 3 connecting an inlet 5 and outlet 7 which define a first (supply) flow direction. A non-return valve 9 is provided in the first conduit 3, which allows the flow of fluid in a first direction being the direction from the inlet 5 to the outlet 7 (and beyond), but prevents fluid flowing in the second direction being from the outlet 7 to the inlet 5. The non-return valve 9 is operable so that it will open to allow fluid to flow in the first direction unless a pressure differential exists (whereby pressure at the downstream side of the non-return valve 9 is greater than pressure at the upstream side thereof) in which case it closes. A second (bypass) conduit 11 is provided connecting the inlet 5 and outlet 7 via a bypass inlet 13 and bypass outlet 15, which bypass inlet 13 and bypass outlet 15 are connected to the first conduit 3 either side of the non-return valve 9. The second conduit is provided with a pumping means 17 (typically an electrically powered pump, such as a centrifugal pump). The pumping means 17 may be sized as appropriate for the purpose. In one preferred embodiment, the device 1 is for use to supply fluid to a plurality of outlets, one of which requires a relatively lower flow (than that supplied to the first conduit 3) at a relatively higher pressure (e.g. a domestic shower) and the second of which requires a relatively higher flow than the first outlet but at a relatively lower pressure. The pumping means 17 may therefore be sized to provide fluid at a low flow rate but high pressure. For example, the pumping means may provide a flow-rate of 6 litres/minute at a pressure of 5 metres head. When a shower (not shown) positioned downstream and fed by the first conduit is actuated (demanding no more than 6 litres/minute) the pumping means 17 pumps fluid through the second conduit 11 creating a relatively low pressure zone 19 immediately upstream of the non-return valve 9 (due to fluid diverting into the second conduit due to the pump) and a relatively high pressure zone 21 immediately downstream of the non-return valve 9 (due to fluid from the second conduit feeding into the first conduit). Accordingly, a pressure differential is created about the non-return valve 9, which duly closes and prevents pressure equalization and any flow through the first conduit. All the fluid supplied to the shower outlet is pumped at the desired pressure (5 metres head) via the second conduit 11. When a second outlet (e.g. a bath) (not shown) served by the first conduit downstream of the device is actuated, which second outlet has a significantly larger demand (e.g. 20 litres/minute) but a low pressure requirement (e.g. 2 metres head), the demand exceeds the capacity of the pumping means 17, thus quickly equalizing the pressure differential about the non-return valve 9, thus causing the non-return valve 9 to open and allow a greater flow-rate of fluid to the outlet via the first conduit 3 at the pressure supplied to the first conduit and the device inlet 5. Thus the device allows fluid to be supplied to an outlet at high pressure for pre-determined flow-rates.

In FIG. 2 is a fluid transit arrangement 100 to a solar heat capture element 101 (e.g. a solar panel) from an intermediate storage tank 103 located 15 metres below. An inlet feed line 105 leads from the tank 103 to the element 101. Three devices 107 according to the invention (and as shown in 207 below) are fitted in series in the feed line 105 and sized to provide the required flow rate at a pressure required to relay fluid successively approximately 5 metres up feed line 105. Accordingly, pumping of fluid is achieved along a narrow bore pipe at relatively high flow rate, using low cost, low power pumps whereby heat is effectively dissipated.

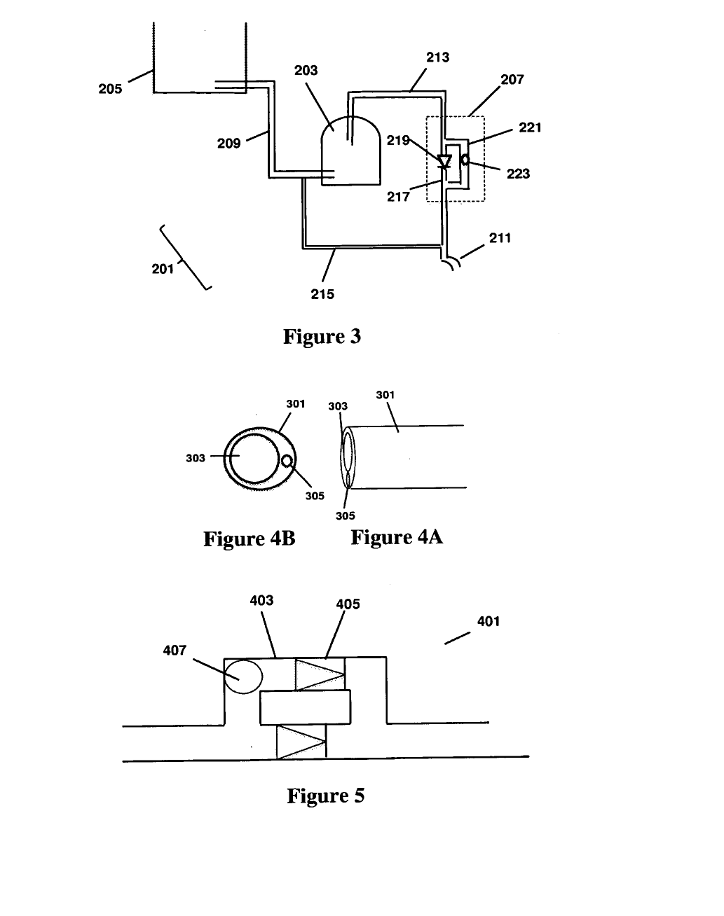

In FIG. 3, there is illustrated a fluid/heat saving arrangement 201 in a domestic plumbing system utilizing the pressure enhancing device 207 according to the present invention. A domestic hot water cylinder 203 is supplied by cold water from a cold water storage tank 205 (or from the mains) via cold water feed 209. Hot water may be drawn from the hot water cylinder 203 on demand by a user via outlet (e.g. tap) 211 via supply feed line 213. In order to ensure that hot water is available to the tap 211 on demand, the supply feed line 213 is linked back to the cold water feed 209 or directly to hot water storage tank 203 via return line 215 to form a circuit comprising hot water cylinder 203-hot water supply line 213-return line 215-hot water cylinder 203. The return line 215 typically has a restricted flow achieved, for example, by a reduced bore compared with the hot water supply line 213. Water lying in the hot water supply line 213 cools over time so that when a user comes to use the tap 211, it is necessary to run off cool water until hot water arrives via hot water supply line 213 at the tap 211. By circulating water through the circuit mentioned above, driven by a pressure enhancement device 207 provided in the hot water supply line 213, hot water may be available upon demand. The device 207 comprises a first conduit 217 fitted with a non-return valve 219 configured to allow flow of fluid in a first direction being from the hot water cylinder 203 to the tap 211 and a second (bypass) conduit 221 provided with a pump 223 capable of pumping fluid through the supply line 213 and back through the return line 215 to the cylinder 203, but having a capacity (flow rate) less than that demanded by the tap in operation whereby on turning the tap 211 on, the non-return valve 219 opens to supply hot water to the tap 211. Optionally, flow through the circuit may be initiated by a manual lever or switch (not shown), associated with the outlet 211 engaging and disengaging a valve or stopper (not shown) in the return line 215.

FIGS. 4a and 4b illustrate a perspective view and cross-section of a tubing 301 according to a related aspect which comprises a first supply conduit 303 of relatively large diameter and a contiguous second conduit 305 (e.g. a return line) of relatively small diameter for use in domestic plumbing such as in a fluid/heat saving arrangement as in FIG. 3. Fittings (not shown) can be provided to connect the first and second conduits 303, 305 to each other or to other conduits or outlets as required.

FIG. 5 shows a particular embodiment of the pressure enhancement 401 (1) device of FIG. 1 in which the second conduit 403 is further provided with a non-return valve 405 downstream of the pump 407. For most applications, this embodiment is less preferred (and the device is absent a non return valve in the second conduit), but it finds application as a pump for use in circulating a fluid into a higher pressure fluid conduit (whereby backflow of fluid is to be avoided), such as a water/heat saving arrangement of FIG. 3 adapted so that the return line feeds into the inlet feed of a domestic combination boiler (not shown).

### EXAMPLES

### Example 1

A supply feed (first conduit) of 22 mm diameter to a shower has an external head of pressure whereby without a pump fluid is supplied to the shower at 3.3 litres per minute, which would be considered a poor shower. The supply feed was then fitted with a device according to the present invention in which the second conduit has a diameter of 15 mm and is fitted with a pump of varying power. The effect of increasing pump power in this situation is examined. The results are shown in Table 1.

TABLE 1

| Pump power/W | Shower flow-rate/Lmin⁻¹ | Notes |
|---|---|---|
| 0 | 3.3 | |
| 15 (12 V) | 6.3 | Pump warm |
| 30 (19 V) | 7.7 | Pump hot but not too hot |
| 60 (24 V) | 8.2 | Pump hot and too hot |

As can be seen from the above, the efficiency of the pump for a particular system drops off dramatically when the power of the pump is increased.

### Example 2

The following sets out the flow and pressure requirements for the application of a device of the present invention in pumping water from a tank at ground level through copper pipe to a solar panel at 15 metres height, using a relay arrangement of three devices in series. The data is summarized in the following table:

TABLE 2

| | Scenario I | Scenario II | Scenario III |
|---|---|---|---|
| Pipe diameter | 8 mm | 10 mm | 15 mm |
| Volume per | 0.05 | 0.78 | 1.77 |
| metre length/l | | | |
| Total volume/l | 0.75 | 1.18 | 2.66 |
| Flow rate | 2.5 l/min | 2.5 l/min | 2.5 l/min |
| Transit time | 18 s | 28 s | 64 s |
| Pipe length | 15 m | 15 m | 15 m |
| Hydraulic head | 15 m | 15 m | 15 m |
| Head loss/m | 0.263 | 0.084 | 0.03 |
| Pressure | 19 m head | 16.3 m head | 15.45 m head |
| required | | | |

In order to achieve the flow rates and pressure required in a smaller diameter pipe, three devices of the present invention may be utilized in relay, sized to pump fluid in three 5 meter sections at the required flow-rate to overcome the head loss significantly more power and cost effectively than a single high pressure pump at ground level.

The invention has been described with reference to preferred embodiments. However, it will be appreciated that variations and modifications can be effected by a person of ordinary skill in the art without departing from the scope of the invention.

1. A device for increasing fluid pressure the device having
a fluid inlet,
a fluid outlet,
a first conduit connecting the fluid inlet and fluid outlet, the first conduit provided with a non-return valve
a second conduit connected to the first conduit by a branch inlet and a branch outlet, the branch inlet and branch outlet configured relative the first conduit to connect the second conduit to the first conduit either side of the non-return valve,
wherein the second conduit is provided with a fluid pumping means.

2. A device as claimed in claim 1, wherein the non-return valve opens when the demand flow-rate exceeds a pre-determined value as determined by the capacity of the pumping means.

3. A device as claimed in claim 1 or claim 2 for use as a shower pump.

4. A device as claimed in claim 1 or claim 2 for use in increasing the pressure of fluid in a branch of a municipal water supply.

5. A device as claimed in claim 1 or claim 2 for use in pumping fluid through a microfluidic device such as an inkjet printer.

6. A device as claimed in claim 1 or claim 2 for use as a medical pump.

7. A device as claimed in claim 6, which device is an implantable arterial pump.

8. A device as claimed in claim 7, which device is for use in the treatment of ischemia.

9. A device as claimed in claim 7 for use in the treatment of ischemia by implanting the device in line in an artery proximal an ischemic tissue area, the device configured to increase the average blood pressure downstream of the device by up to 20% (e.g up to 10%), by continuous flow of the pump or by pulsed flow of the pump substantially synchronized with heart-induced flow.

10. A method of increasing the pressure of fluid through a fluid conduit (e.g. at an outlet supplied by a fluid conduit), the method comprising fitting the fluid conduit with a non-return (or one-way) valve whereby the valve allows fluid through the conduit in the direction of the outlet but not in the opposing direction, the method further comprising connecting a by-pass conduit to the fluid conduit before and after (i.e. upstream and downstream of) the non-return valve and providing in the by-pass conduit a pumping means for pumping fluid through the bypass conduit from upstream of the non-return valve to downstream of the non-return valve, the pump means being sized to provide the desired pressure.

11. A method for selectively increasing the pressure of a fluid through a conduit at low flow rates, the method comprising providing a device as defined in claim 1 in which the pump is sized to provide a desired increase in pressure to a pre-determined maximum flow rate, above which the fluid is provided downstream of the device at substantially the same pressure as upstream of the device.

13. A fluid saving arrangement, comprising a heated fluid source, an outlet for drawing said fluid, a fluid supply line for supplying fluid to the outlet from the fluid source, a return line for returning fluid to the fluid source, a return outlet for feeding fluid from the return line to the fluid source (or a temporary reservoir associated with the fluid source) and a return inlet feeding fluid from the fluid supply line to the return line at a point proximal to the fluid outlet, the arrangement being characterized in that there is provided in the fluid supply line (or the return line) a device, as defined in claim 1 above, for circulating said fluid from the heated fluid source, through the fluid supply line, through the return line and back to the fluid source.

14. A method for providing a fluid outlet with hot fluid from a heated fluid source without having to run off residual cool fluid, the method comprising providing a return line from a supply line feeding the outlet from the source at a position proximal the fluid outlet and providing in the fluid supply line a device as defined in claim 1 for pumping fluid from the heated fluid source, through the supply line and back to the fluid source via the return line, whereby heated water is available to be drawn from the fluid outlet from the position proximal the fluid outlet on demand.

15. A device for enhancing the pressure in a fluid conduit as hereinbefore described with reference to the drawings.
